(19) United States
(12) Patent Application Publication
(10) Pub. No.: US 2006/0165023 A1
(43) Pub. Date: Jul. 27, 2006

(54) Wireless gateway and controller for network protector relays

(76) Inventors: Mark A. Faulkner, Greenwood, SC (US); Michael R. Howard JR., Coraopolis, PA (US); John R. Moffat, Greenwood, SC (US); James L. Lagree, Robinson Township, PA (US); Thomas J. Kenny, Pittsburgh, PA (US)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 11/041,607

(22) Filed: Jan. 24, 2005

(51) Int. Cl. H04B 7/00

(52) U.S. Cl. 370/310

(57) ABSTRACT

A power distribution monitoring system includes a wireless gateway/controller, a network protector subnetwork including a plurality of network protectors and a portable electronic device having wireless communication functionality. Each of the network protectors is in electronic communication with the wireless gateway/controller. The wireless gateway/controller receives data from one or more of the network protectors, and wirelessly transmits at least a portion of the data to the portable electronic device. Also, a method of monitoring a power distribution system including receiving data at a first location from a network protector subnetwork that includes a plurality of network protectors, wirelessly transmitting at least a portion of the data from the first location, and wirelessly receiving the at least a portion of the data at a second location separate from the first location.

### BACKGROUND OF THE INVENTION

1. Field of the Invention

The present invention relates to power distribution systems, and in particular to a system for communication with and/or controlling network protector relays using a wireless gateway and controller.

2. Background Information

Low-voltage secondary power distribution networks consist of interlaced loops or grids supplied by two or more sources of power, in order that the loss of any one source will not result in an interruption of power. Such networks provide the highest possible level of reliability with conventional power distribution and are, normally, used to supply high-density load areas, such as a section of a city, a large building or an industrial site.

Each source supplying the network is typically a medium voltage feeder system including a switch, a voltage reducing transformer and a network protector. As is known in the art, a network protector is an apparatus used to control the flow of electrical power to a distribution network and includes a circuit breaker and a control relay which opens the circuit to the transformer upon detection of abnormal current flow. Specifically, the control relay typically senses the network voltages, the line currents, the phasing voltage (voltage across the network contacts) and executes algorithms to initiate breaker tripping or re-closing actions. Trip determination is based on detecting reverse power flow, that is, power flow from the network to the primary feeder. Example network protector relays are described in U.S. Pat. Nos. 3,947,728; 5,822,165; 5,844,781; and 6,504,693, owned by the assignee hereof, the disclosures of which are incorporated herein by reference. Thus, in the system just described, voltage is safely supplied to the network through the transformers, which have their secondary or low-voltage windings connected to the network through the circuit breaker of the corresponding network protector. The transformers and network protectors are often located in vaults, frequently underground.

As is also known, control relays typically include a microcontroller-based circuit which monitors the network phase to neutral voltages, the phasing voltages, and the feeder currents. Traditionally, if a problem with a transformer and/or network protector arose, a worker would need to manually inspect the installation to investigate the problem by physically entering the vault which houses the transformer and/or network protector. This presented serious safety concerns for workers, as the environment inside the vaults is dangerous due to, among other things, the relatively high voltages, currents and temperatures involved.

In order to alleviate this safety concern, the control relays in some systems include a communication module for wired communication with a remote station over a communication network to allow remote access to protector measurement data of interest for both diagnostic and control purposes. In such systems, the control relays perform breaker trip and re-close functions, and the connection to the communications network enables remote tripping, or more specifically, “remote open and block open” control. This allows users, such as electric utility maintenance personnel, to remotely open, and under certain conditions, close the circuit breaker of a network protector, as described in detail in, for example, U.S. Pat. Nos. 5,936,817 and 6,504,693, the disclosures of which are incorporated herein by reference. FIG. 1 is a block diagram of an example of one such prior art communication subsystem 5. As seen in FIG. 1, communication subsystem 5 includes a number of network protectors 10, which, as described above, may be provided inside a vault located underground. Specifically, as shown in FIG. 1, network protectors 10 are connected to a communication cable 15, preferably through an electrical isolation element 20, which, as described below, will allow remote access to protector measurement data of interest. Each network protector 10 includes a communication module (not shown) for communicating with a remote station 25, such as personal computer (PC), over the communication cable 15 (possibly through electrical isolation element 20). Communication subsystem 5 may utilize a protocol, known as INCOM, which is proprietary to the assignee hereof, and communication cable 15 may be an INCOM cable provided by the assignee hereof. The remote station 25 receives protector measurement data of interest from and sends circuit breaker open and/or close commands to one or more of the network protectors 10 over the communication cable 15. Such a system is, however, typically very expensive to implement, as large amounts of cable must be run over long distances.

U.S. Pat. No. 6,628,496 describes a protection system for an electricity network that includes a box containing a processor that causes circuit breakers to open in the event of faults being sensed by current and/or voltage sensors on the lines of the network connected to the circuit breakers. The system also includes a short range radio data transmission link between the box and a remote appliance such as a mobile telephone, PDA or laptop. As a result, the remote appliance is able to receive data from and send commands to the box wirelessly. This system, however, is a point-to-point system, meaning that a communication channel must be established individually with each such box in order to collect data therefrom or to provide commands thereto. In order to do so, the remote appliance must be brought within the RF transmission range of each such box, which, in most cases, will require a worker to travel over significant distances. As a result, performing diagnostic and control functions with such a protection system is inefficient and time consuming. In addition, such a system requires each box to have its own wireless communication device, which adds to the cost of the system overall.

### SUMMARY OF THE INVENTION

These needs, and others, are addressed by the present invention which provides a power distribution monitoring system that includes a wireless gateway/controller, a network protector subnetwork including a plurality of network protectors and a portable electronic device having wireless communication functionality such that the wireless gateway/controller and the portable electronic device are adapted for wireless communication with another. Each of the network protectors is in electronic communication, preferably by a wired connection although a wireless connection is possible, with the wireless gateway/controller. The wireless gateway/controller receives data from one or more of the network protectors, and wirelessly transmits at least a portion of the data to the portable electronic device. The data may include one or more of network phase to neutral voltages, transformer phase to neutral voltages, feeder currents, breaker status information, breaker counter information and a stored log of recent breaker events.

In the preferred embodiment, the wireless gateway/controller selectively requests and receives the data from the network protectors. The wireless gateway/controller may selectively request the data in response to a data request wirelessly received by the wireless gateway/controller from the portable electronic device. The wireless gateway/controller may also selectively provide control commands, such as breaker trip commands and breaker re-close commands, to the network protectors. Such control commands may be provided based on analyses of the data performed by the wireless gateway/controller or based on the receipt of a command form the portable electronic device.

The present invention also relates to a method of monitoring a power distribution system, including receiving data at a first location from a network protector subnetwork that includes a plurality of network protectors, wirelessly transmitting at least a portion of the data from the first location, and wirelessly receiving the at least a portion of the data at a second location separate from the first location, such as with a portable electronic device. The receiving step may include selectively requesting and receiving the data from the network protectors, such as in response to a data request received at the first location form the second location. The method may further include selectively transmitting control commands from the first location to the network protectors based on an analysis of the data or based on a command received at the first location form the second location.

### BRIEF DESCRIPTION OF THE DRAWINGS

A full understanding of the invention can be gained from the following description of the preferred embodiments when read in conjunction with the accompanying drawings in which:

FIG. 1 is a block diagram of an example of a prior art power distribution monitoring and control system; and

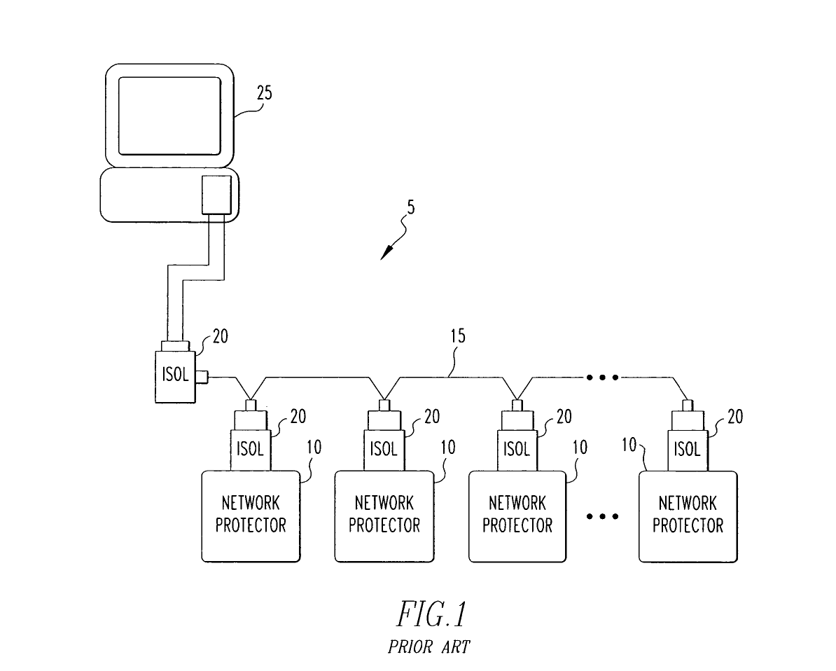

FIG. 2 is a block diagram of a power distribution monitoring and control system according to the present invention.

### DESCRIPTION OF THE PREFERRED EMBODIMENTS

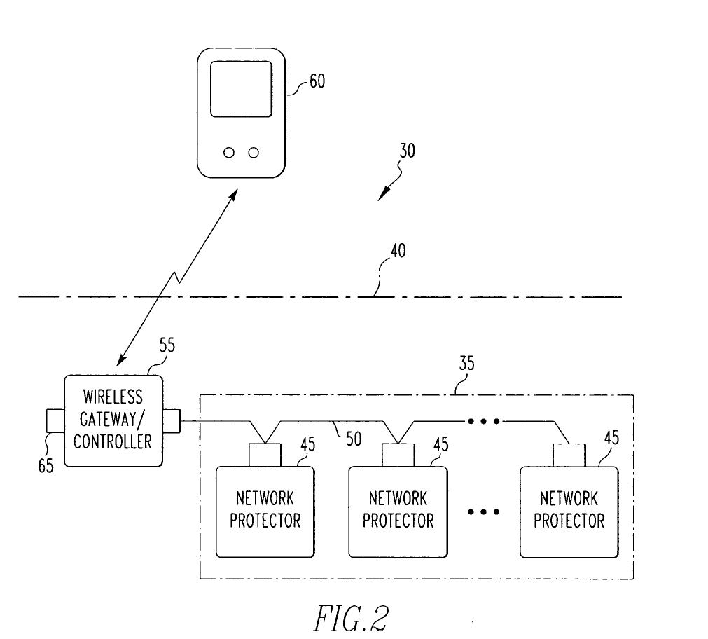

FIG. 2 is a block diagram of a monitoring and control system 30 according to the present invention. Monitoring and control system 30 includes subnetwork 35 that typically, although not necessarily, is located underground, such as under street 40. Subnetwork 35 includes a plurality of network protectors 45 as described above (including at least a circuit breaker and a control relay), each one operatively coupled to a transformer (not shown) and an associated electrical network (not shown). As seen in FIG. 2, each network protector 45 is connected to communication cable 50, which may be an INCOM cable using the proprietary protocol of the assignee hereof as described above, although any suitable electrical networking cabling may be used. Network protectors 45 in subnetwork 35 may be located in geographic proximity with one another, such as at a particular location within an industrial site, or may be located geographically separate from one another, such as in separate parts of an industrial site or even a city. Communication cable 50 is, in turn, connected to wireless gateway/controller 55. Wireless gateway/controller is an electronic device that includes among other components: (i) a processor, such as, without limitation, a microprocessor such as a microcontroller, that is programmed for performing the various operations and functions described herein; (ii) a wireless communications device capable of wirelessly transmitting and receiving data using any of several known wireless protocols, including, without limitation, short-range RF protocols such as Bluetooth or Zigbee; and (iii) a memory for storing data and routines executable by the processor.

Wireless gateway/controller 55 is able to communicate with each network protector 45 in subnetwork 35 over communication cable 50. In particular, wireless gateway/controller 55 is adapted to selectively request and receive data from and provide control commands to each network protector 45. As such, wireless gateway/controller 55 is able to collect data, such as, without limitation, the network phase to neutral voltages, the transformer phase to neutral voltages, the feeder currents, the circuit breaker status (open or closed), and a stored log or buffer of recent breaker events, that is collected by the microcontroller-based control relay of each network protector 45, and is able to selectively provide breaker trip and re-close commands to each network protector 45. For this purpose, each network protector 50 in subnetwork 35 is provided with a unique address to enable wireless gateway/controller 55 to identify it and distinguish it from the other network protectors 45.

Monitoring and control system 30 further includes portable electronic device 60, which may be, for example and without limitation, a laptop computer, a PDA, or a cell phone. Portable electronic device 60 is provided with wireless communication functionality that is compatible with the wireless communication system employed by wireless gateway/controller 55 to enable portable electronic device 60 and wireless gateway/controller 55 to communicate with one another. As a result, portable electronic device 60 is able to wirelessly request and receive from wireless gateway/controller 55 the data that has been collected from each of the network protectors 45. In addition, portable electronic device 60 is able to wirelessly transmit control commands for one or more of the network protectors 45 to wireless gateway/controller 55 which then relays them to the appropriate network protector 45 over communication cable 50. As will be appreciated, wireless gateway/controller 55 is provided with appropriate hardware and software to enable the data the be converted from the format in which it is received over communication cable 50 (e.g., INCOM) to the format that is required for processing by wireless gateway/controller 55 (e.g., RS232) and to the format that is required to transmit it wirelessly to portable electronic device 60 (e.g., Bluetooth) and vice versa.

In the preferred embodiment of the present invention, monitoring and control system 30 is a master/slave system. Specifically, wireless gateway/controller 55 is the system master and network protectors 45 are the slaves, such that data communication is initiated by wireless gateway/controller 55 either on its own as described below or upon receipt of a request from a portable electronic device 60. In one particular embodiment, wireless gateway/controller may be programmed to automatically and continuously, periodically or upon the occurrence of an event, such as a breaker trip, collect data from one or more of and preferably all of the network protectors 45 included within subnetwork 35. Once collected, wireless gateway/controller will then store (log) the data, preferably in a non-volatile manner, for subsequent transmission to a portable electronic device 60 or a remote station as described below. In one particular implementation during each scan of the network protectors 45 included within subnetwork 35, wireless gateway/controller 55 collects the trip state data from each network protector 45 and the remaining data (e.g., the network phase to neutral voltages, the transformer phase to neutral voltages, the feeder currents, and a stored log or buffer of recent breaker events) from only one network protector 45 (the one network protector changing each scan).

In addition, wireless gateway/controller 55 may be programmed with appropriate intelligence to analyze the data that is receives and generate and transmit appropriate control commands to one or more of the network protectors 45 based thereon. For example, in a spot network, the breaker of a particular network protector 45 may be tripped open due to a light load condition (such as a night in a building), and wireless gateway/controller 55 may detect the light load condition based on the data it collects and issue a “protective close command” to close the open breaker. The programmed intelligence may also be able to perform diagnostic functions. For example, wireless gateway/controller 55 may be programmed to monitor the speed at which the breakers of the network protectors 45 open or data received from auxiliary inputs (e.g., the state of the trip coil) to the network protectors, and generate and issue a message to a portable electronic device 60 when it is determined that service may be needed.

As noted above, network protectors 45 may be provided within a vault underground. Typically, to provide adequate protection, such vaults are made of concrete and are rather thick (2-3 inches or more) and, as a result, RF signals or the like may not be able to penetrate the concrete to reach the network protector 45. Fortunately, such vaults are also provided with a grating or the like for ventilation purposes, and such gratings provide a path for transmission of the RF signals in cases where the wireless gateway/controller 55 is also placed within the vault. As will be appreciated, the wireless gateway/controller 55 need not be paced within the vault, and instead may be placed in a more convenient, easily accessible location separate from the network protectors 45 themselves.

As seen in FIG. 2, wireless gateway/controller 55 may include an uplink port 65 to enable it to communicate directly with a remote station (not shown), such as personal computer (PC), over a wired or long-range wireless connection. Uplink port 65 allows wireless gateway/controller 55 to transmit the data that is collected from network protectors 45 to the remote station. Uplink port 65 also allows the remote station to transmit control commands to wireless gateway/controller 55, which in turn are sent to the appropriate network protector(s) 45.

While specific embodiments of the invention have been described in detail, it will be appreciated by those skilled in the art of various modifications and alternatives to those details could be developed in light of the overall teachings of the disclosure. For example, while for clarity of description only one subnetwork 35 is shown being connected to one wireless gateway/controller 55, it will be appreciated that a number of subnetworks 35, each including one or more network protectors 45, may be connected to a single wireless gateway/controller 55, and that a number of wireless gateway/controllers 55, each being connected to one or more subnetworks 35, may be included in a system within the scope of the present invention. Accordingly, the particular arrangements disclosed are meant to be illustrative only and not limiting as to the scope of the invention which is to be given the full breadth of the claims appended and any and all equivalents thereof.

What is claimed is:

1. A power distribution monitoring system, comprising:
a wireless gateway/controller;
a network protector subnetwork, said network protector subnetwork including a plurality of network protectors, each of said network protectors being in electronic communication with said wireless gateway/controller; and
a portable electronic device, said portable electronic device having wireless communication functionality, said wireless gateway/controller and said portable electronic device being adapted for wireless communication with another:
wherein said wireless gateway/controller receives data from one or more of said network protectors, and wirelessly transmits at least a portion of said data to said portable electronic device.

2. The power distribution monitoring system according to claim 1, wherein each of said network protectors are in wired electronic communication with said wireless gateway/controller.

3. The power distribution monitoring system according to claim 2, wherein each of said network protectors are connected to an electrical cabling system, and wherein said electrical cabling system is connected to said wireless gateway/controller.

4. The power distribution monitoring system according to claim 1, wherein said wireless gateway/controller selectively requests and receives said data from said one or more of said network protectors.

5. The power distribution system according to claim 4, wherein said wireless gateway/controller selectively requests said data in response to a data request wirelessly received by said wireless gateway/controller from said portable electronic device.

6. The power distribution monitoring system according to claim 1, wherein said wireless gateway/controller selectively provides control commands to said one or more of said network protectors.

7. The power distribution monitoring system according to claim 6, wherein said wireless gateway/controller generates said control commands based on at least a second portion of said data.

8. The power distribution system according to claim 6, wherein said wireless gateway/controller selectively provides said control commands in response to a command wirelessly received by said wireless gateway/controller from said portable electronic device.

9. The power distribution monitoring system according to claim 6, wherein said control commands include one or more of breaker trip commands and breaker re-close commands.

10. The power distribution monitoring system according to claim 1, wherein said data includes one or more of network phase to neutral voltages, phasing voltages and angles, feeder currents, breaker status information, operations counter information and a stored log of recent breaker events.

11. A method of monitoring a power distribution system, comprising:
receiving data at a first location from a network protector subnetwork, said network protector subnetwork including a plurality of network protectors, said data being transmitted by one or more of said network protectors;
wirelessly transmitting at least a portion of said data from said first location; and
wirelessly receiving said at least a portion of said data at a second location separate from said first location.

12. The method according to claim 11, wherein said at least a portion of said data is received at said second location by a portable electronic device.

13. The method according to claim 11, wherein said receiving step comprises receiving said data at said first location over a wired connection.

14. The method according to claim 11, wherein said receiving step comprises selectively requesting and receiving said data from said one or more of said network protectors.

15. The method according to claim 11, wherein said receiving step comprises selectively requesting and receiving said data from said one or more of said network protectors in response to a data request wirelessly received at said first location from said second location.

16. The method according to claim 12, wherein said receiving step comprises selectively requesting and receiving said data from said one or more of said network protectors in response to a data request wirelessly received at said first location from said portable electronic device.

17. The method according to claim 11, further comprising selectively transmitting control commands from said first location to said one or more of said network protectors.

18. The method according to claim 11, further comprising generating control commands based on at least a second portion of said data and selectively transmitting said control commands from said first location to said one or more of said network protectors.

19. The method according to claim 11, further comprising selectively transmitting control commands from said first location to said one or more of said network protectors in response to a command wirelessly received at said first location from said second location.

20. The method according to claim 17, wherein said control commands include one or more of breaker trip commands and breaker re-close commands.

21. The method according to claim 11, wherein said data includes one or more of network phase to neutral voltages, phasing voltages and angles, feeder currents, breaker status information, operations counter information and a stored log of recent breaker events.
